(19) United States
(12) Patent Application Publication
(10) Pub. No.: US 2025/0303768 A1
(43) Pub. Date: Oct. 2, 2025

(54) PRINTING SYSTEM AND PRINTING DEVICE CORRECTION VALUE ACQUISITION METHOD

(71) Applicant: SEIKO EPSON CORPORATION, Tokyo (JP)

(72) Inventor: Eishin YOSHIKAWA, Matsumoto (JP)

(21) Appl. No.: 19/087,707

(22) Filed: Mar. 24, 2025

(30) Foreign Application Priority Data
Mar. 26, 2024 (JP) 2024-049146

(51) Int. Cl. B41J 29/393; H04N 1/407; H04N 1/60

(52) U.S. Cl. CPC B41J 29/393; H04N 1/4078; H04N 1/6005; B41J 2029/3935

(57) ABSTRACT

A printing system includes a printing device 20 that has a print head 21 and that is configured to print a test pattern, an information terminal 30 that has a capturing section 31 configured to capture the test pattern, that is configured to couple to the printing device 20, and that is physically separate from the printing device 20, and a control device 40 for calculating correction values of the printing device 20 based on image data of a capturing result of the test pattern, wherein the test pattern includes a grayscale pattern with a plurality of patches of varying densities and the control device 40 calculates the correction value based on comparison of brightness of plural sets of image data, the plural sets of image data include first image data obtained by capturing the grayscale pattern from a first direction of a capturing range of the capturing section 31 and second image data obtained by capturing the grayscale pattern from a second direction different from the first direction in the capturing range of the capturing section 31.

The present application is based on, and claims priority from JP Application Serial Number 2024-049146, filed Mar. 26, 2024, the disclosure of which is hereby incorporated by reference herein in its entirety.

### BACKGROUND

### 1. Technical Field

The present disclosure relates to a printing system and a printing device correction value acquisition method for calculating a correction value of a printing device.

### 2. Related Art

In general, adjustment is indispensable for a mechanical apparatus, and this is no exception for an inkjet printer, which is a printing device. In the inkjet printer, the influence of the adjustment accuracy on the image quality is significant, and the desired image quality cannot be obtained if the adjustment is not performed correctly.

The inkjet printer can print a predetermined test pattern for adjustment and can adjust the machine element by correcting the print data based on a result of visual checking of the printed test pattern by a user.

However, when a general user is the one making the adjustment, even if a test pattern is prepared, it is difficult to make a correct determination. Therefore, the adjustment cannot be performed correctly, and a desired image quality may not be obtained. In other words, it is necessary to make the adjustment correctly, but it is also difficult to make the adjustment.

In order to compensate for this, a dedicated sensor for reading the test pattern is provided in the printing device, and adjustment is performed using this sensor. However, because the dedicated sensor is necessary, the cost is increased, and the size of the printing device is increased by the size of the sensor.

For this reason, a device disclosed in JP-A-2006-121486 is known as a device for improving the adjustment accuracy, in the related art. In the technique disclosed in JP-A-2006-121486, an imaging device such as a digital camera separate from a printing device is used. The printing device prints a test pattern, and the imaging device images the test pattern. A printing device generates printing correction data, which is a correction value based on the captured image data.

In the case of using an imaging device separate from the printing device as in JP-A-2006-121486, there is a high possibility that the shadow of the imaging device is captured when the test pattern is captured. In an image of a test pattern in which shadows appear, a grayscale value different from an original grayscale value is acquired as image data, and correct print correction data cannot be acquired.

On the other hand, an imaging device such as a digital camera includes a lighting source. However, when an image of an adjustment pattern is captured, the distance between the lighting source and the adjustment pattern is short, and thus a gradient of illuminance is likely to occur. Therefore, since a large variation occurs depending on the position of the lighting source, such a lighting source cannot be used. In other words, it is necessary to capture an image of the adjustment pattern by using a peripheral lighting source, but there is a high possibility that a shadow will appear as described above.

### SUMMARY

The present disclosure provides a printing system including
a printing device that includes a print head and that is configured to print a test pattern;
an information terminal that includes an imaging section configured to capture the test pattern, that is configured to couple to the printing device, and that is physically separate from the printing device; and
a control device for calculating correction values of the printing device based on image data of a capturing result of the test pattern, wherein
the test pattern includes a grayscale pattern with a plurality of patches of varying densities and
the control device calculates the correction value based on comparison of brightness of plural sets of image data, the plural sets of image data include first image data obtained by capturing the grayscale pattern from a first direction of a capturing range of the capturing section, and second image data obtained by capturing the grayscale pattern from a second direction different from the first direction in the capturing range of the capturing section.

### BRIEF DESCRIPTION OF THE DRAWINGS

FIG. 1 is a schematic diagram of a printing system according to an embodiment of the present disclosure.

FIG. 2 is a schematic block diagram of the printing device and the information terminal.

FIG. 3 is a diagram showing a test pattern and image data.

FIG. 4 is a flowchart of a program for generating the print correction data.

FIG. 5 is a flowchart of a program for generating the print correction data according to a modification.

FIG. 6 is an illustration showing a test pattern according to a modification.

FIG. 7 is a flowchart of a program for generating the print correction data according to a modification.

FIG. 8 is an example of a histogram of the luminance and the number of pixels in the region.

### DESCRIPTION OF EMBODIMENTS

Hereinafter, embodiments of the present disclosure will be described with reference to the drawings.

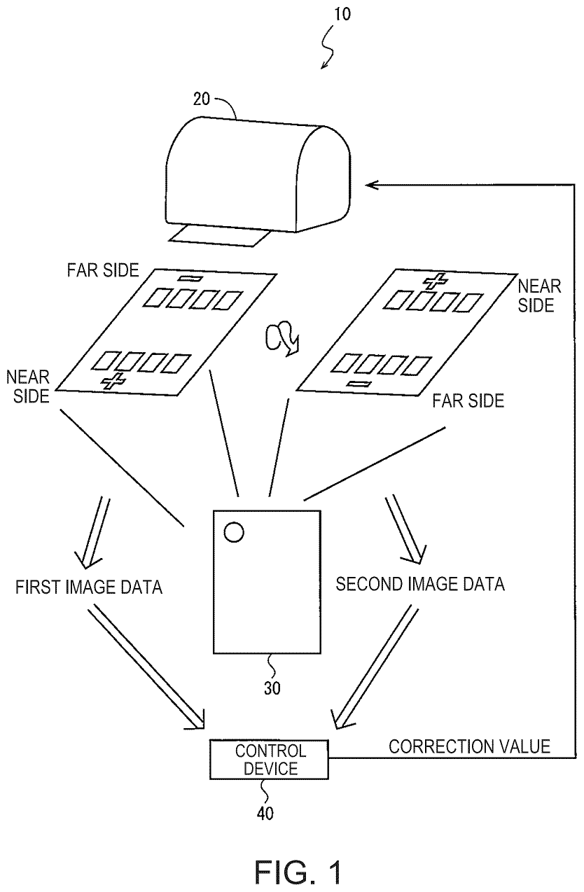

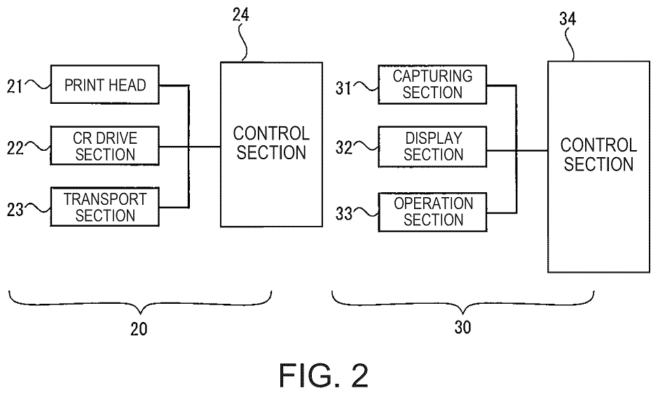

FIG. 1 is a schematic view showing a printing system according to an embodiment of the present disclosure, and FIG. 2 is a schematic block diagram showing a printing device, an information terminal, and a control device.

In these figures, a printing system 10 includes a printing device 20, an information terminal 30, and a control device 40, and the printing device 20, the information terminal 30, and the control device 40 are connected to each other by wireless coupling. In this example, they are coupled wirelessly, but some or all of them may be coupled by wire. Through either a wireless or wired coupling, the image data generated by the information terminal 30 can be transmitted to the control device 40, and the correction value generated by the control device 40 can be transmitted to the printing device 20. Note that the printing device 20, the information terminal 30, and the control device 40 do not need to be directly coupled to each other and may be indirectly coupled via a network or the like, for example.

The printing device 20 is an inkjet printer and includes a print head 21 which ejects ink droplets, a CR drive section 22 which causes the print head 21 to reciprocate, a transport section 23 which transports a print medium, a control section 24 which controls these sections, and the like. When receiving the print data, the control section 24 controls the print head 21, the CR drive section 22, and the transport section 23 to perform printing on the print medium. A predetermined test pattern with a plurality of patches of different densities for adjustment can be printed, and when a correction value based on image data obtained by capturing an image of the test pattern is input, printing can be performed by correcting the print data based on the correction value.

The information terminal 30 is an information process device represented by a smartphone or the like and includes a capturing section having 31 an imaging element with a predetermined resolution, a display section 32 that displays the capturing range of the imaging section, an operation section 33, a control section 34 that performs various kinds of control, and the like. The information terminal 30 can capture an image of a subject with the capturing section 31 by operating the operation section 33 and output the captured image as image data. The control section 34 can display various messages, marks, and the like on the display section 32 based on the image of the subject.

The information terminal 30 can capture an image of the test pattern with the capturing section 31 and can be electrically coupled to and physically separate from the printing device 20 as described above. The electrical coupling may be a state in which the image data and the correction value data can be transmitted via the control device 40 as described above. On the other hand, the information terminal 30 including a capturing section 311 is physically separate from the printing device 20 and is not incorporated in the printing device 20. When the information terminal 30 captures the test pattern with the capturing section 31, it captures the image a plurality of times while changing the capturing direction. FIG. 1 shows a state in which the test pattern is turned upside down and imaged twice. The first image is referred to as first image data, and the subsequent image is referred to as second image data. Note that, as will be described later, third image data captured by further changing the direction may be used.

The control device 40 is a device having a function of calculating a correction value of the printing device 20 by analyzing a test pattern included in an image when image data is acquired. Specifically, it includes a central processing unit (CPU) such as a processor, a read only memory (ROM), and a random access memory (RAM), and stores a program for analyzing and calculating the test pattern included in the acquired image data. The control device 40 may be included in the printing device 20 or the information terminal 30.

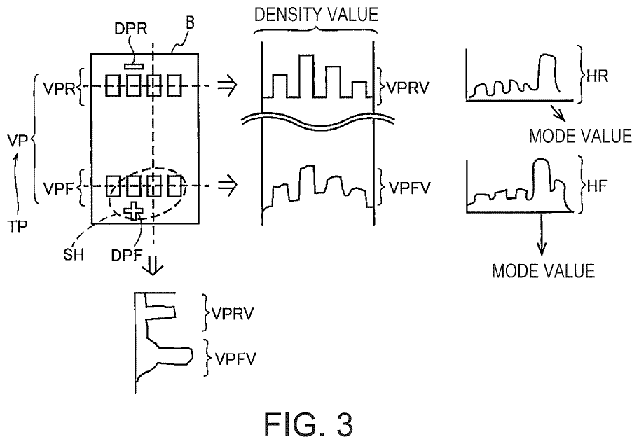

FIG. 3 shows a test pattern and image data.

The test pattern TP printed on the print medium B by the control section 24 of the printing device 20 includes a grayscale pattern VP having a plurality of patches with different densities and direction indicating patterns DPF, DPR indicating the direction of the print medium B. In this example, as the grayscale pattern VP, one row of grayscale pattern VPF is printed on the near side and one row of grayscale pattern VPR is printed on the far side. Although the test pattern TP includes only the grayscale pattern VP as an analysis target, the test pattern TP may include a ruled line pattern formed of a linear pattern.

In the present embodiment, by printing both the near side direction indicating pattern DPF and the far side direction indicating pattern DPR as the direction indicating pattern, the direction from the near side to the far side of the print medium B is indicated, and the direction can be specified. However, any method may be used as long as the direction of print medium B can be specified. For example, it is possible to indicate the orientation of print medium B with only one side, and it is acceptable to print on only one side. In addition, the shape is free and can be changed. Moreover, the direction indicating pattern is arbitrary.

When the image data obtained by imaging the grayscale pattern VP is analyzed, the density value of the image data is used. In the image data of print medium B shown in the upper left of the drawing, the density value of the portion indicated in dashed line in the horizontal direction should originally have a flat shape in both the solid area and the patch area, as in the graph of the grayscale value shown in the center of the drawing. Here, the lower the density value, the brighter it is, and the higher the density value, the darker it is. This is opposite when expressed by a grayscale value, and a portion with a high grayscale value is bright and a portion with a low grayscale value is dark. In a case where the medium is a plain white background, a portion where the patch is not printed has a high grayscale value, and a portion where the patch is printed has a low grayscale value corresponding to the density value of the patch.

When an image of the test pattern TP is captured by the information terminal 30 such as a smartphone, even if the user consciously attempts to prevent any shadow from appearing, it is not actually possible to avoid shadows from appearing. In addition, general users are not very conscious of carefully capturing an image. For this reason, quite a few shadows tend to appear in the image data.

Among the grayscale patterns VP in FIG. 3, the grayscale pattern VPR on the far side has no shadows, but the grayscale pattern VPF on the near side has shadows SH. When the smartphone is brought close to the print medium B to some extent and an image is captured, the shadow SH is likely to appear on the grayscale pattern VPF on the near side in particular.

The density value VPFV of image data of the grayscale pattern VPF, in which the shadow SH appears, increases unevenly as shown in the center of the drawing. On the other hand, the density value VPRV of the image data of the grayscale pattern VPR, in which the shadow SH does not appear, changes in a stepwise manner like a straight line as shown in the center of the drawing and is not affected by shadows.

On the other hand, in the image data of print medium B, the density value of the portion, indicated by the dashed line in the vertical direction, changes as in the graph of the grayscale value shown at the bottom of the page. Although the shadow SH does not appear in the far side grayscale pattern VPR, it appears in the near side grayscale pattern VPF. Therefore, the density value VPRV of the image data of the far side grayscale pattern VPR, which is not affected by the shadows SH, changes stepwisely shown as a straight line and is not influenced by the shadows, but the density value VPFV of the image data of the near side grayscale pattern VPF, which is affected by the shadows SH, becomes unevenly high.

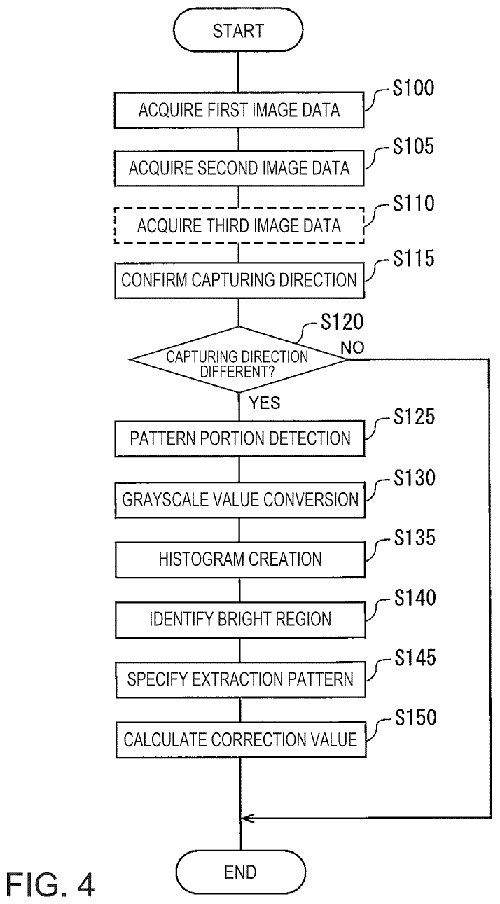

FIG. 4 is a flowchart showing a program for generating print correction data.

In advance, the user checks the near side direction indicating pattern DPF and the far side direction indicating pattern DPR shown on the print medium B, performs imaging the first time in the direction indicated by the direction indicating pattern, and performs imaging the second time in the direction opposite to the direction indicating pattern by changing the direction by 180 degrees. The image data captured at the first time is first image data, and the image data captured at the second time is second image data. Note that the image data may be acquired as third image data captured at a third time by further changing the direction.

The control device 40 acquires the first image data in step S100 and acquires the second image data in step S105. If a third image of the third time is available, the third image is acquired in step S110.

Next, in step S115, the control device 40 checks the capturing direction. The direction indicating patterns DPF, DPR are included in the image data, and the control device 40 analyzes the image data and searches for the direction indicating patterns DPF, DPR. Since the direction indicating patterns DPF, DPR indicate the near side and the far side, respectively, if the direction indicating patterns DPF, DPR are found, it is possible to know in which direction the print medium B appears in the image.

As described above, the direction is changed by 180 degrees between the first and second imaging. In step S120, the control device 40 determines whether the capturing directions of each set of image data are different. The control device 40 calculates the correction value based on plural sets of image data including first image data obtained by capturing the grayscale pattern from a first direction of the capturing range of the capturing section 31 and second image data obtained by capturing the grayscale pattern from a second direction different from the first direction of the capturing range of the capturing section 31. Therefore, when the correction value is calculated based on the first image data and the second image data, if the capturing directions of the image data are not different from each other, the process is terminated without calculating the correction value. When the capturing directions of the image data are different from each other, the correction value is calculated as follows.

Here, capturing from the first direction of the capturing range of the capturing section 31 means imaging from a direction in which the grayscale pattern displayed in the capturing range of the capturing section 31 is in a predetermined first direction. That is, capturing the grayscale pattern from the second direction different from the first direction of the capturing range of the capturing section 31 means that the test pattern displayed in the capturing range of the capturing section 31 is imaged from a direction that is the second direction, which is different from the first direction. As a capturing method for this purpose, capturing may be performed a plurality of times such that the capturing section 31 is oriented differently with respect to the print medium on which the grayscale pattern is printed, or capturing may be performed the plurality of times by changing the orientation of the print medium on which the grayscale pattern is recorded with respect to the capturing section 31.

In addition, 180 degrees means the opposite direction, and an angle exceeding 180 degrees or an angle less than 180 degrees is included as long as it is substantially the opposite direction.

In step S125, the control device 40 detects a portion of the grayscale pattern. The grayscale pattern has a plurality of patches with different densities, and a site can be detected by searching for a predetermined patch. In order to detect the portion, a marker may be printed when the grayscale pattern of the print medium B is printed, and the portion may be specified by detecting the marker.

When the site is specified, the control device 40 converts the image data into grayscale values in step S130. The grayscale value depends on the image data because the image data can be used as it is in some cases and the grayscale value can be obtained by performing a predetermined calculation process on the image data in other cases. When no arithmetic processing is required, the arithmetic processing may be omitted.

After the grayscale value is obtained, the control device 40 generates a histogram in step S135. For this histogram, a grayscale values histogram is generated for a portion of the same grayscale pattern for each of plural sets of image data having different capturing directions. Thereafter, the control device 40 specifies a bright region in step S140. Grayscale values histograms HF, HR are shown on the right side of FIG. 3. There are various methods for specifying a bright region, and a region can be determined to be a dark region if it can be determined that the region has moved to the dark side as a whole by generating the histograms HF, HR for different capturing directions with the same grayscale pattern. As a method of specifying a bright region, a mode value as shown in the figure may be used.

After determining the bright region, the control device 40 specifies a grayscale pattern to be extracted and used in step S145. That is, the control device 40 calculates the correction value by using the brighter grayscale value in the first image data and the second image data. A bright region can be estimated as a region in which there is a high possibility that the shadows will not appear, and a correct correction value can be calculated based on the density value or the grayscale value of each patch portion of the grayscale pattern.

By calculating the correction value using the values of the high grayscale level (=bright) regions, it is possible to perform correction that suppresses the influence of the shadows.

When the correction value is calculated, only the grayscale pattern of the bright region may be adopted, or an average value of the grayscale patterns of a plurality of regions may be adopted.

Then, the control device 40 calculates a correction value in step S150. That is, the control device 40 calculates the correction value based on plural sets of image data including the second image data obtained by imaging the grayscale pattern from a second direction, which is different from the first direction, in the capturing range of the capturing section 31.

As described above, in this printing system, the correction value of the printing device is acquired based on the capturing result obtained by capturing the predetermined test pattern, and the test pattern including a grayscale pattern that has a plurality of patches with different densities and that was printed by the printing device.

In this printing system, a method for obtaining correction values for the printing device is executed. Through the processing steps S100 to S120 executed by the control device 40, it performs a step of acquiring first image data by capturing the test pattern from a predetermined first direction, and a step of acquiring second image data by capturing the grayscale pattern from a second direction different from the first direction. Then, by the processing of steps S125 to S150, the correction values are acquired based on the first image and the second image.

Since the region where the test pattern and the shadows overlap are different in the imaging data captured from different angles, it is possible to calculate the correction value in which the influence of the shadows is suppressed by using both of these images.

Furthermore, although the first image data and the second image data are captured by changing the direction by 180 degrees, the capturing direction is one in which a correction value that most excludes the influence of shadows can be calculated when capturing the same test pattern.

In the case where the third image data of the third time is obtained and used, the image is captured from more than two directions, and the correction values are calculated using the result, whereby the correction values from which the influence of the shadows is further eliminated can be calculated.

In the above-described embodiment, the influence of shadows is eliminated by searching for the grayscale value of the bright region in the image data. However, a modification in which the influence of shadows is eliminated by using plural sets of image data captured in different capturing directions will be described.

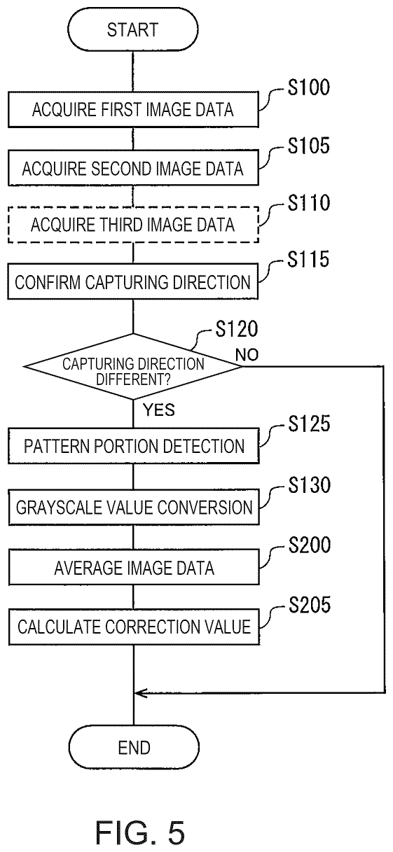

FIG. 5 is a flowchart of a program for generating the print correction data according to the modification.

The processing from step S100 to step S130 is the same as the processing shown in FIG. 4.

The control device 40 does not specify a bright region in steps S135 to S140, but in step S200, it specifies an average value by averaging the grayscale values of the image data of the pattern portions included in the first and second image data. Then, in step S205, a correction value is calculated based on the average value of the grayscale values.

In this way, since the correction value can be calculated without performing the process of specifying the bright region, the process can be performed with a low load. In this case, the correction accuracy is inferior to the correction using a high grayscale value, but priority can be given to the processing speed. In this case, although the accuracy is reduced, the correction accuracy can be reliably improved because the correction values affected by the shadows are averaged with the correction values not affected by the shadows.

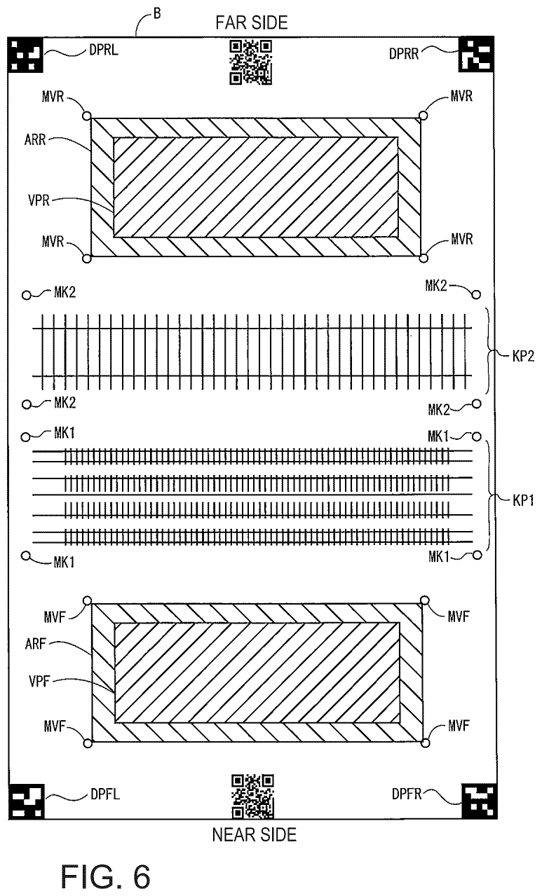

FIG. 6 is an illustration showing a test pattern according to a modification.

The test pattern TP includes the grayscale patterns VPF, VPR having a plurality of patches with different densities, the direction indicating patterns DPFL, DPFR, DPRL, DPRR indicating the direction of the print medium B, and two grayscale patterns KP1, KP2. Around each pattern, a position marker is printed to facilitate the detection of the region.

The grayscale pattern VPF is disposed at a position on the near side of the medium B, and the grayscale pattern VPR is disposed at a position on the far side of the medium B. In the drawing, the patches are indicated by oblique lines, but in practice, a plurality of patches having different densities are printed side by side. A first region ARF and a second region ARR are set so as to surround the grayscale patterns VPF and VPR, respectively. In the drawing, the regions are indicated by oblique line hatching, but are actually left blank, and markers MVF, MVR are printed at the four corners so as to surround each region. When the image data is generated later, positions of the markers MVF, MVR are identified, and the first region ARF and the second region ARR inside the markers can be extracted.

The grayscale pattern VPF included in the first region ARF corresponds to a first grayscale pattern, and the grayscale pattern VPR included in the second region ARR corresponds to a second grayscale pattern.

The direction indicating patterns DPFL, DPFR, DPRL, DPRR are printed at the four corners to indicate the orientation of the print medium B. They represent a near left corner, a near right corner, a far left corner, and a far right corner, respectively. In this example, the accurate orientation of print medium B can be identified by identifying the positions of the four corners.

In addition, the two grayscale patterns KP1, KP2 are printed between the first region ARF and the second region ARR so as not to overlap each other from the near side to the far side, and similarly, position markers MK1, MK2 are printed at the four corners around each pattern.

In the present embodiment, the two grayscale patterns VPF, VPR are printed at separate positions on the near side and the far side of the print medium. Accordingly, it is possible to expect an effect that the shadows which is likely to be generated on the near side when the near side and the far side are switched and captured affects only one of the grayscale patterns VPF, VPR and hardly affects the other grayscale pattern. A brighter region may be adopted as the first region ARF by comparing the brightness of the first region ARF in the first image data, which is obtained by capturing the grayscale pattern from a first direction in the capturing range, with the brightness of the first region ARF in the second image data, which is obtained by capturing the grayscale pattern from a second direction that is different from the first direction in the capturing range of the capturing section 31. Of course, the second region ARR may also be compared in the same manner. At this time, if the first region ARF is brighter in the first image and the second region ARR is brighter in the second image, it may be sufficient to adopt only the grayscale pattern of the bright region.

However, considering that the location of shadow generation is unspecified, not only the near side and the far side, but also even when they are formed at different positions on the print medium B, it is possible to expect an effect that it is possible to select the side which is not considerably influenced by the shadows.

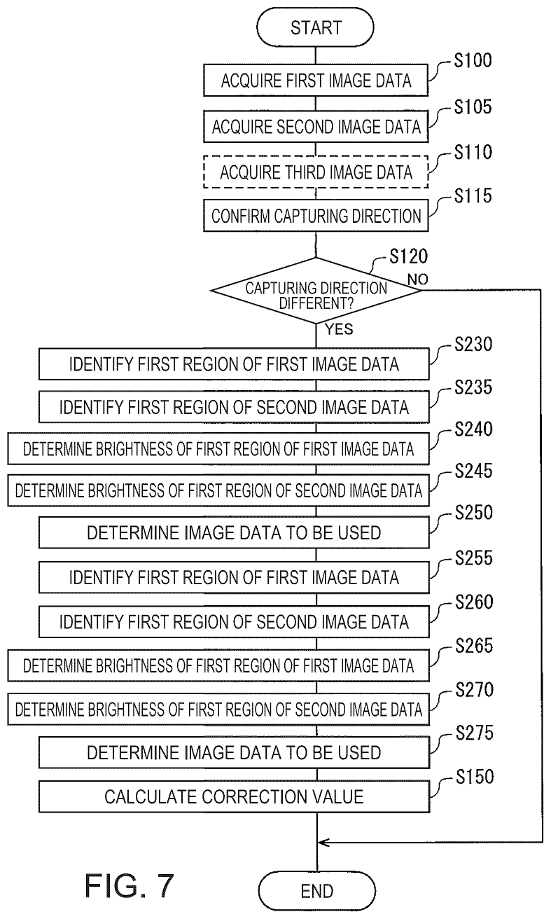

FIG. 7 is a flowchart of a program for generating the print correction data according to a modification. The same reference numerals as in FIG. 4 denote the same processing steps. In step S115, the capturing directions of the first and second images are checked based on the direction indicating patterns DPFL, DPFR, DPRL, DPRR at the four corners.

If it is determined in step S120 that the capturing directions of each image are different, the first region of the first image data is specified in step S230. Markers MVF are printed at the four corners of the first region ARF, the positions of the markers MVF at the four corners are specified from the first image data, and a region surrounded by these markers is specified as the first region ARF. Similarly, in step S235, the positions of the markers MVF at the four corners are specified in the second image, and a region surrounded by these markers is specified as the first region ARF.

In steps S240 to S250, image data in which the first region is brighter is specified by comparing the first region of the first image data with the first region of the second image data. Here, the brighter image when the same region is compared does not mean that each pixel of one test pattern is compared and the brighter one is used. This is intended to use a result determined to be a brighter region by comparing each grayscale pattern when divided by a predetermined region.

Therefore, first, in step S240, the brightness of the first region ARF of the first image data is specified, and in step S245, the brightness of the first region ARF of the second image data is specified. Then, in step S250, the image data to be used is specified based on the specified brightness. The brightness may be judged based on the grayscale values histograms HF, HR in step S140. The mode value as described above may be used.

The mode value of the grayscale value means a luminance value that appears most frequently among the grayscale values acquired from the imaging data. That is, calculating the correction value using the mode value of the grayscale values of the pixels in the first image data and the second image data means comparing the most frequent luminance value amongst the luminances in the first image and the most frequent luminance value amongst the luminances in the second images, and using the brighter one.

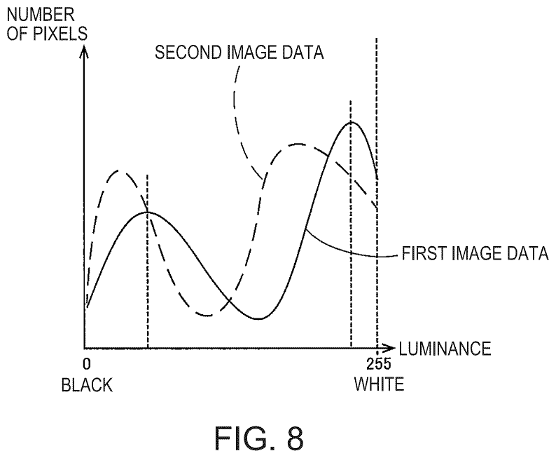

FIG. 8 is an example of a histogram of the luminance and the number of pixels in the region.

In FIG. 8, the horizontal axis represents luminance or a grayscale value, and data closer to white is closer to 255, and data closer to black is closer to 0.

For example, when the entire test pattern is captured, many pixels in the imaged data indicate the color of the paper, and therefore, when the test pattern is formed on white paper such as plain paper, a peak in which the number of pixels is large appears on the right side as in the histogram of the drawing. The peak appearing on the left side is a grayscale value representing the color of the portion where the test pattern is printed. The position in the left-right direction varies according to the color forming the test pattern.

If the histogram is created in units of the first region or the second region described above, the area of the grayscale pattern is larger than the margin, and thus the number of pixels of the luminance of the portion forming the test pattern may be larger than the number of pixels of the luminance of the paper white.

Since the objective of the present disclosure is to use the “brighter one,” the first and second image data are compared at the “vertex of the peak of paper white” or the “vertex of the peak of the test pattern,” and the image data with the higher peak value on the higher grayscale value side is used. This “vertex of the peak” refers to the mode value, which is the number of pixels having luminance with the highest frequency of occurrence among plural peaks in brightness.

In FIG. 8, the grayscale value of the mode value in the first image data is higher than that in the second image data. Therefore, the first image data is used to calculate the correction value.

In a case where the brightness is judged as the region, the determination may be performed based on the brightest portion of the plain white region. Specifically, the determination is made using the pixel maximum luminance. The “maximum luminance” means the highest luminance value among the luminance values acquired from the imaging data.

In this way, when calculating the correction value, the correction value may be calculated using the mode value of the luminance of the pixels of the first image data and the second image data, or the correction value may be calculated using the maximum luminance of the pixels of the first image data and the second image data. Of course, it is also possible to calculate the correction value by specifying the brighter image data by a method other than these.

In other words, the control device 40 compares the first region ARF and the second region ARR in each of the first image data and the second image data, and calculates the correction value by using image data of a brighter region.

In this example, the position is specified by detecting the markers MVF printed at the four corners of the first region ARF by image processing, but this is merely an example. For example, in the case of a grayscale pattern, patches of a plurality of densities are printed adjacent to each other to form one continuous solid region, and one solid region can be regarded as the test pattern of the first region or the test pattern of the second region.

It is also possible to form a marker capable of indicating a direction at one place instead of the four corners, and to specify a rectangular region with reference to the detection position of the marker.

In subsequent steps S255 to S275, the same processing is performed on the second region ARR, and a brighter region of the first and second image data is specified.

When the brighter region is identified in the first and second images, the control device 40 calculates correction values in step S150 using the image data of the brighter region. There is a high possibility that the shadows will not appear in a bright portion, and it can be estimated that the grayscale value of the grayscale pattern is more accurately reflected.

Needless to say, the present disclosure is not limited to the above-described embodiment. Though it goes without saying for those skilled in the art, the following are disclosed as an embodiment of the present disclosure:
mutually replaceable components, configurations, and the like disclosed in the above embodiment can be applied by appropriately changing the combination thereof;
although not disclosed in the above embodiments, components, configurations, and the like which are publicly known and can be mutually replaced with the components, the configurations, and the like disclosed in the above embodiments may be appropriately replaced, and the combination thereof may be changed and applied; and
although not disclosed in the above-described embodiments, components, configurations, and the like that can be assumed as substitutes for the components, configurations, and the like disclosed in the above-described embodiments by those skilled in the art on the basis of known techniques and the like may be appropriately substituted, and combinations thereof may be changed and applied.

What is claimed is:

1. A printing system comprising:
a printing device that includes a print head and that is configured to print a test pattern;
an information terminal that includes an imaging section configured to capture the test pattern, that is configured to couple to the printing device, and that is physically separate from the printing device; and
a control device for calculating correction values of the printing device based on image data of a capturing result of the test pattern, wherein
the test pattern includes a grayscale pattern with a plurality of patches of varying densities and
the control device calculates the correction value based on comparison of brightness of plural sets of image data, the plural sets of image data include first image data obtained by capturing the grayscale pattern from a first direction of a capturing range of the imaging section and second image data obtained by capturing the grayscale pattern from a second direction different from the first direction in the capturing range of the imaging section.

2. The printing system according to claim 1, wherein
as the comparison of brightness, the control device calculates the correction value using the mode value of the luminance of pixels of the first image data and the second image data.

3. The printing system according to claim 1, wherein
as the comparison of brightness, the control device calculates the correction value by using the maximum luminance of the pixels of the first image data and of the second image data.

4. The printing system according to claim 1, wherein
the first direction and the second direction are different from each other by 180 degrees.

5. The printing system according to claim 1, wherein
the test pattern includes
a first grayscale pattern formed in a first region and
a second grayscale pattern formed in a second region, and
as comparison of brightness, the control device
compares the first region included in the first image data with the first region included in the second image data and
compares the second region included in the first image data with the second region included in the second image data.

6. The printing system according to claim 1, wherein
the plurality of image data further includes third image data obtained by capturing the grayscale pattern from a third direction different from the first direction and the second direction.

7. A printing device correction value acquisition method for acquiring a correction value of a printing device based on a capturing result obtained by capturing a predetermined test pattern, the test pattern including a grayscale pattern that has a plurality of patches with different densities and that was printed by the printing device, the printing device correction value acquisition method comprising:
acquiring first image data obtained by capturing the test pattern from a predetermined first direction;
acquiring second image data obtained by capturing an image of the grayscale pattern of the test pattern from a second direction different from the first direction; and
acquiring the correction value based on a comparison of brightness between the first image data and the second image data.
